(19) United States
(12) Patent Application Publication
(10) Pub. No.: US 2001/0052936 A1
(43) Pub. Date: Dec. 20, 2001

(54) Digital still camera having a volatile internal memory device with a surplus area for storing photographed image data

(75) Inventor: Hironori Nagai, Tokyo (JP)

Correspondence Address: YOUNG & THOMPSON, 745 SOUTH 23RD STREET 2ND FLOOR, ARLINGTON, VA, 22202

(73) Assignee: NEC Corporation

(21) Appl. No.: 09/876,987

(22) Filed: Jun. 11, 2001

(30) Foreign Application Priority Data
Jun. 9, 2000 (JP) 173365/2000

(51) Int. Cl. H04N 5/76

(52) U.S. Cl. 348/233; 348/552

(57) ABSTRACT

In a digital still camera which contains an internal RAM (a volatile internal memory device) and to/from which an external RAM (a nonvolatile external memory device) is attachable/detachable, the internal RAM has a work area for an image processing process and a surplus area for storing image data photographed by the digital still camera. An image data storage device receives the image data from a photographing processing section. When the external RAM is attached to the digital still camera, an image data managing unit 31 stores the image data in the external RAM. When the external RAM is detached from the digital still camera, the image data managing unit 31 stores the image data in the surplus area of the internal RAM.

### BACKGROUND OF THE INVENTION

This invention relates to a digital still camera for electronically photographing an image to store image data indicative of the image.

A digital still camera of the type described contains a volatile internal memory device (which is called an “internal RAM(random access memory)”) for use in an image processing process. In addition, a nonvolatile external memory device (which is called an “external RAM”) is attachable to and detachable from the digital still camera. Accordingly, a conventional digital still camera is constructed so that image data photographed by the digital still camera cannot be stored therein if the external RAM is absent or is detached from the digital still camera.

A method of storing image data in the conventional digital still camera is disadvantageous in that there is an obstacle for selling a digital still camera of low-price model. This is because the conventional digital still camera cannot photograph and store image data if the external RAM is absent or is detached from the digital still camera and then makers must sell the digital still camera with the external RAM attached thereto. In addition, the method of storing the image data in the conventional digital still camera is also disadvantageous in that a sudden rise in the cost price is not avoided. This is because a nonvolatile RAM must be added in the digital still camera if a similar function of a conventional internal RAM exclusive camera is added to the camera matched with the external RAM.

In addition, various preceding arts related to the digital still camera of the type described are already known. By way of example, Japanese Unexamined Patent Publication of Tokkai No. Hei 8-205,067 or JP-A 8-205067 describes “MEMORY CARD AND CAMERA” to utilize effectively both of advantages of a recording medium with fast write speed and erasure speed and of the recording medium not needing a backup power supply. In JP-A 8-205067, a memory card (or an external RAM) is made up of a card incorporating a recorder to record image data and an adapter connecting to the card and incorporating a storage device to store image data obtained by image pickup. A nonvolatile recording medium is adopted for the recording device incorporated in the card without any operating power supply. A volatile recording medium is adopted for the storage device built in the adapter easily having an operating power supply. With this structure, it is possible to obtain both advantage of the nonvolatile recording medium and the volatile recording medium. However, JP-A 8-205067 does not describe an internal RAM contained in the camera.

In addition, Japanese Unexamined Patent Publication of Tokkai No. Hei 10-056,606 or JP-A 10-056606 discloses “ELECTRONIC STILL CAMERA” to drastically improve the degree of freedom of image pickup and to easily conduct diversified image pickup. The electronic still camera disclosed in JP-A 10-056606 is provided with an image pickup mechanism such as a shutter mechanism, an image pickup mechanism drive means to drive the image pickup mechanism, and an image means providing an output of a control signal so as to operate the image pickup mechanism drive means according to a preset secular drive condition. In addition, the electronic still camera is also provided with a shutter switch biasing a control signal output from the image pickup control means to the image pickup mechanism drive means to store image information received by an image pickup light receiving section via the shutter mechanism to a memory. Furthermore, in the electronic still camera as above, the image pickup control means is provided with a drive condition setting means for setting freely a secular drive condition of the image pickup mechanism drive means. However, JP-A 10-056606 does not describe as regards a kind of the memory although JP-A 10-056606 describes as regards storing of the image information in the memory.

Furthermore, Japanese Granted Patent Publication of Tokkyo No. 2,710,394 or JP-B 2710394 discloses “ELECTRONIC CAMERA” to always secure a backup function with a memory to the full of a capacity and to prevent a shutter chance to be missed even at the time of successive photographing by executing a change to a new solid memory when the capacity of the incorporated solid memory reaches a limit and transferring stored information to it. According to JP-B 2710394, when a memory card (or an external RAM) is attached to an electronic camera, a camera power source is inputted and a series of camera actions is executed, first, whether a protection is executed or not is checked, and when it does not exist, a parameter to indicate a recording condition for each frame number of the card to be inserted is read in. Here, the parameter is one to indicate that the frame number is unrecorded when it is 0, and one to indicate that the number is already recorded when it is 1. By the read-in, when the memory capacity reaches the limit, namely, the full, an incorporated memory (or an internal RAM) is changed to the new memory, the stored information stored in the memory is transferred to it, and the photographing is continued. However, in JP-B 2710394, a temporarily storing exclusive memory is required as the internal RAM.

### SUMMARY OF THE INVENTION

It is therefore an object of this invention to provide a digital still camera which is capable of photographing and storing image data by using only an internal RAM for an image processing process without adding hardware (H/W) to a camera matched with an external RAM.

Other objects of this invention will become clear as the description proceeds.

According to an aspect of this invention, a digital still camera contains a volatile internal memory device for use in an image processing process. A nonvolatile external memory device is attachable to and detachable from the digital still camera. The volatile internal memory device comprises a work area for the image processing process and a surplus area for storing image data photographed by the digital still camera.

In the above-mentioned aspect of this invention, the digital still camera preferably may comprise a storing arrangement for temporarily storing the image data in the surplus area of the volatile internal memory device when the nonvolatile external memory device is detached from the digital still camera. The digital still camera preferably further may comprise a transferring arrangement for transferring the image data stored in the surplus area to the nonvolatile external memory device when the nonvolatile external memory is attached to the digital still camera. The digital still camera desirably further may comprise a backup arrangement for backing up the volatile internal memory device so that stored contents of the a volatile internal memory device do not disappear although a power source switch of the digital still camera is put into an off state. The digital still camera desirably further may comprise a transferring arrangement for transferring the image data stored in the surplus area to a host system.

According to another aspect of this invention, a method is for storing image data photographed by a digital still camera which contains a volatile internal memory device for use in an image processing process and to/from which a nonvolatile external memory device is attachable/detachable. The method comprises the step of using a surplus area for storing the image data except for a work area for the image processing process.

In the above-mentioned method, processed image data after image processing may be stored in the surplus area. In this event, the method further may comprise the steps of determining whether the nonvolatile external memory device is attached to or detached from said digital still camera, and when the nonvolatile external memory device is attached to the digital still camera, of transferring stored contents of the surplus area to the nonvolatile external memory device. The method further may comprise the steps of carrying out image processing on raw image data to produce the processed image data when the nonvolatile external memory device is detached from the digital still camera, and of temporarily storing the processed image data in the surplus area.

In the above-mentioned method, raw image data before image processing may be stored in the surplus area. Under the circumstances, the method further may comprise the steps of determining whether the nonvolatile external memory device is attached to or detached from the digital still camera, when the nonvolatile external memory device is attached to the digital still camera, of carrying out image processing on the raw image data of the surplus area to produce processed image data, and of transferring the processed image data to the nonvolatile external memory device. The method further may comprise the step of temporarily storing, as the raw image data, picked-up data photographed by the digital still camera in the surplus area when the nonvolatile external memory device is detached from the digital still camera.

### BRIEF DESCRIPTION OF THE DRAWING

FIG. 1 is a block diagram of a digital still camera according to a first embodiment of this invention;

FIG. 2 is a view showing an internal RAM for use in the digital still camera illustrated in FIG. 1;

FIG. 3 is a flowchart for use in describing operation of the digital still camera illustrated in FIG. 1;

FIG. 4 is a time chart for use in describing operation of the digital still camera illustrated in FIG. 1;

FIG. 5 is a block diagram of a digital still camera according to a second embodiment of this invention;

FIG. 6 is a flowchart for use in describing operation of the digital still camera illustrated in FIG. 5; and

FIG. 7 is a time chart for use in describing operation of the digital still camera illustrated in FIG. 5.

### DESCRIPTION OF THE PREFERRED EMBODIMENTS

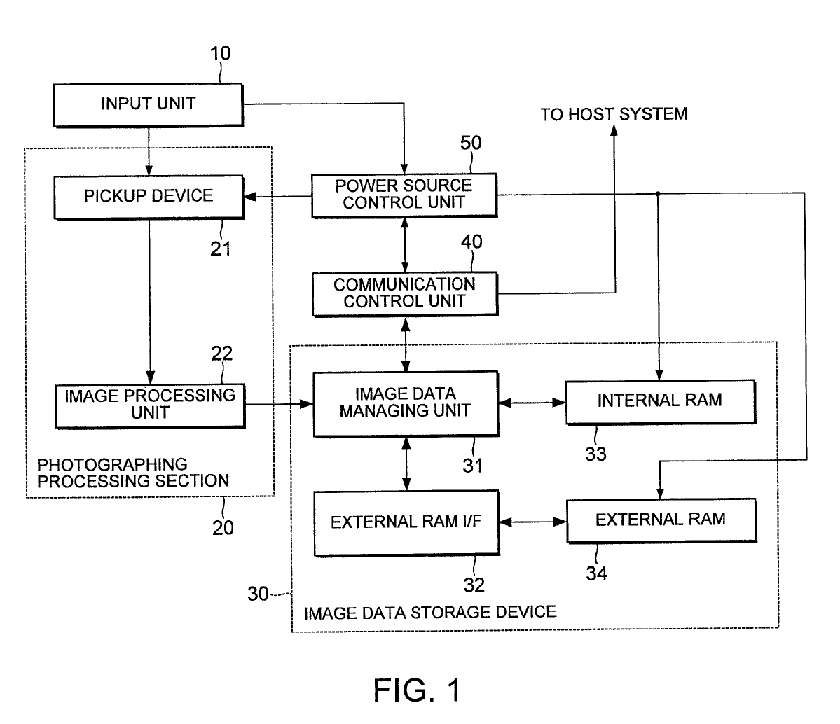

Referring to FIG. 1, the description will proceed to a digital still camera according to a first embodiment of this invention. The illustrated digital still camera comprises an input unit 10 including a shutter bottom, a power source switch, or the like, a photographing processing section 20, an image data storage device 30 for holding or storing image data, a communication control unit 40 for exchanging the image data with a host system, and a power source control unit 50 for controlling a power source for supplying each component of the digital still camera with power.

The photographing processing section 20 comprises a pickup device 21 such as a charge coupled device (CCD) and an image processing unit 22. The pickup device 21 picks up an image to convert the image into digital data or picked-up data. The image processing unit 22 processes the picked-up data into processed image data.

The image data storage device 30 comprises an image data managing unit 31, an external RAM interface (I/F) 32, an internal RAM 33 and an external RAM 34. The image data managing unit 31 manages, in accordance with the presence or absence of the external RAM 34, reading/writing and arrangement of the processed image data. The external RAM interface 32 detects the presence or absence of the external RAM 34. When the external RAM 34 is present or is attached to the digital still camera, the external RAM interface 32 exchanges data with the external RAM 34.

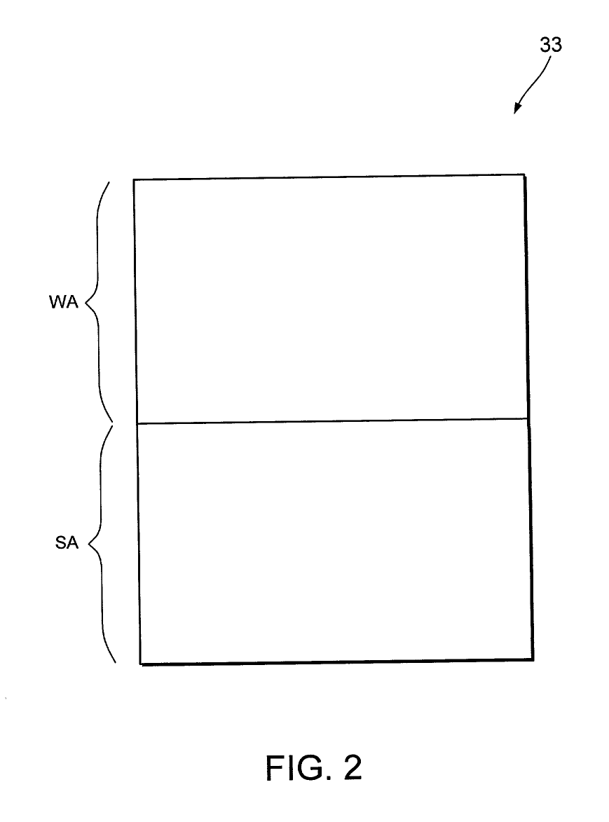

Turning to FIG. 2, the internal RAM 33 is volatile and comprises a work area WA and a surplus area SA. That is, the internal RAM 33 acts as a volatile internal memory device. The work area WA is an area for storing firmware (F/W) for an image processing process. The surplus area SA is an area for storing the processed image data in the manner which will become clear as the description proceeds. When the processed image data is stored in the surplus area SA of the internal RAM 33, the internal RAM 33 is always supplied with the power source although the power source switch (not shown) is turned off. As a result, the surplus area SA stores or holds the processed image data therein. It is desirable that the internal RAM 33 has a storage capacity which is equal to 4 megabytes (MB) or more. This is because it will be assumed that the processed image data is compressed to about 200 kilobytes (KB) per piece. The work area WA has a storage capacity of about 2 MB and the surplus area SA can store at least ten pieces of the processed image data.

Turning back to FIG. 1, the external RAM 34 is nonvolatile and is attachable to or detachable from the digital still camera. That is, the external RAM 34 acts as a nonvolatile external memory device. As a result, it is possible for the host system to directly read or write the stored image data from or in the external RAM 34. Under the circumstances, when the processed image data is stored in the surplus area SA of the internal RAM 33 at a time when the external RAM 34 is attached to the digital still camera, the processed image data stored in the internal RAM 33 is transferred to the external RAM 34 in order to prevent the processed image data from disappearing.

The communication control unit 40 establishes communication between the host system and the digital still camera. The communication control unit 40 receives the processed image data from the image data storage device 30 to transfer the processed image data to the host system. In a case where only the internal RAM 33 can use, the communication control unit 40 transfers the processed image data to the host system by communication.

It is desirable that the communication control unit 40 has a transfer rate which is equal to 200 KB/second or more. This is because it is possible to transfer a piece of the processed image data at a speed of about one piece per second so that any user does not feel late. In dependency on a type of the communication control unit 40, the communication control unit 40 may be switched by the power source from the host system such as a universal serial bus (USB). When it is judged that power on standby is insufficient to holding the data in the internal RAM 33 with the processed image data stored in the surplus area SA of the internal RAM 33, the power source is not switched.

The power source control unit 50 controls a supply state of the power source for each hardware (H/W) such as the pickup device 21, the internal RAM 33, the external RAM 34, and the communication control unit 40. Responsive to an operation mode of the digital still camera, the power source control unit 50 supplies the power source to only a part to be operated and stops supply of the power source for unnecessary parts. When the processed image data is stored in the surplus area SA of the internal RAM 33, the power source control unit 40 supplies the power source to the internal RAM 33 although the power source switch is turned off and the internal RAM 33 continues to hold the processed image data.

Although description has been made as regards structure of the first embodiment of this invention, a detailed description of the photographing processing section 22 is omitted. This is because the photographing processing section 22 is well known in the art and is not directly related to this invention.

In FIG. 1, the image data storage device 30 receives the processed image data prepared by the photographing processing section 20. The image data managing unit 31 stores the processed image data in the external RAM 34 when the external RAM 34 is present or is attached to the digital still camera. The image data managing unit 31 stores the processed image data in the internal RAM 33 when the external RAM 34 is detached from the digital still camera.

It will be assumed that the power source switch of the digital still camera is turned off by operating the input unit 10. In this event, when the processed image data is stored in the surplus area SA of the internal RAM 33, the power source control unit 50 supplies a minimum of power to the internal RAM 33 to make the internal RAM 33 hold the processed image data. Accordingly, it is possible to deal with the internal RAM 33 so as to just like be nonvolatile.

The processed image data stored in the surplus area SA of the internal RAM 33 is transferred to the external RAM 34 by the image data managing unit 31 when the external RAM 34 is present or is attached to the digital still camera. Accordingly, it is possible to secure the processed image data.

In addition, it is possible to transfer the processed image data to the host system by using the communication control unit 40 although an external memory (the external RAM 34) is not available.

As described above, the digital still camera is available without adding hardware (H/W) although the external RAM 34 is separately sold in order to make the digital still camera low cost. In addition, it is possible to realize the digital still camera matched with the external RAM 34.

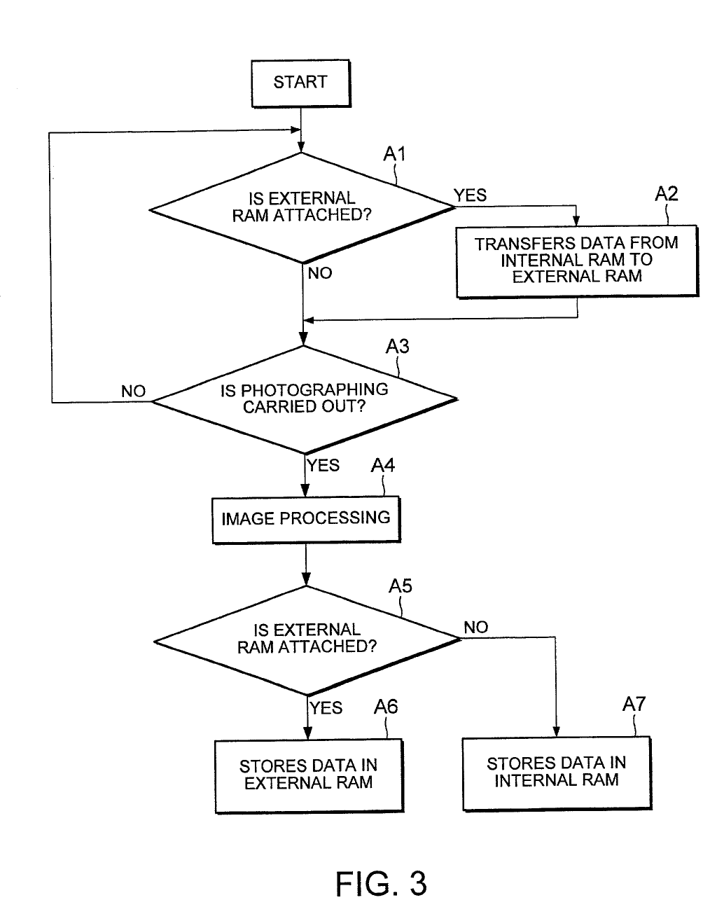

Turning to FIG. 3, description will be made as regards operation of the digital still camera illustrated in FIG. 1.

The external RAM interface 32 always monitors whether or not the external RAM 34 is attached to or detached from the digital still camera at a step A1. When the external RAM 34 is attached to the digital still camera, the image data managing unit 31 receives a notice from the external RAM interface 32. If the processed image data is stored in the surplus area SA of the internal RAM 33, the image data managing unit 31 transfers the processed image data to the external RAM 34 as far as a capacity of the external RAM 34 permits at a step A2. Although a file name of the processed image data is ordinarily stored with the number in the order of photographing the digital still camera, in this case, the file number is rewritten, in accordance with an image number of the external RAM 34, from the following.

When photographing is carried out in the photographing processing section 20 to prepare the processed image data, the image data managing unit 31 receives a notice from the photographing processing section 20 at a step A3. After the photographing processing section 20 prepares or processes the processed image data at a step A4, the image data managing unit 31 makes the external RAM interface 32 confirm the presence or absence of the external RAM 34 at a step A5. When the external RAM 34 is present or is attached to the digital still camera, the step A5 is followed by a step A6 at which the image data managing unit 31 stores the processed image data in the external RAM 34 through the external RAM interface 32. When the external RAM 34 is absent or is detached from the digital still camera, the step A5 proceeds to a step A7 at which the image data managing unit 31 stores the processed image data in the surplus area SA of the internal RAM 33.

When the power source of the digital still camera is turned off by operating the input unit 10, the power source control unit 50 stops supply of the power source to each hardware (H/W) of the digital still camera. However, the power source control unit 50 carries out supply of the lowest necessary power to the internal RAM 33 in order to hold the processed image data of the volatile RAM when the processed image data is stored in the surplus area SA of the internal RAM 33.

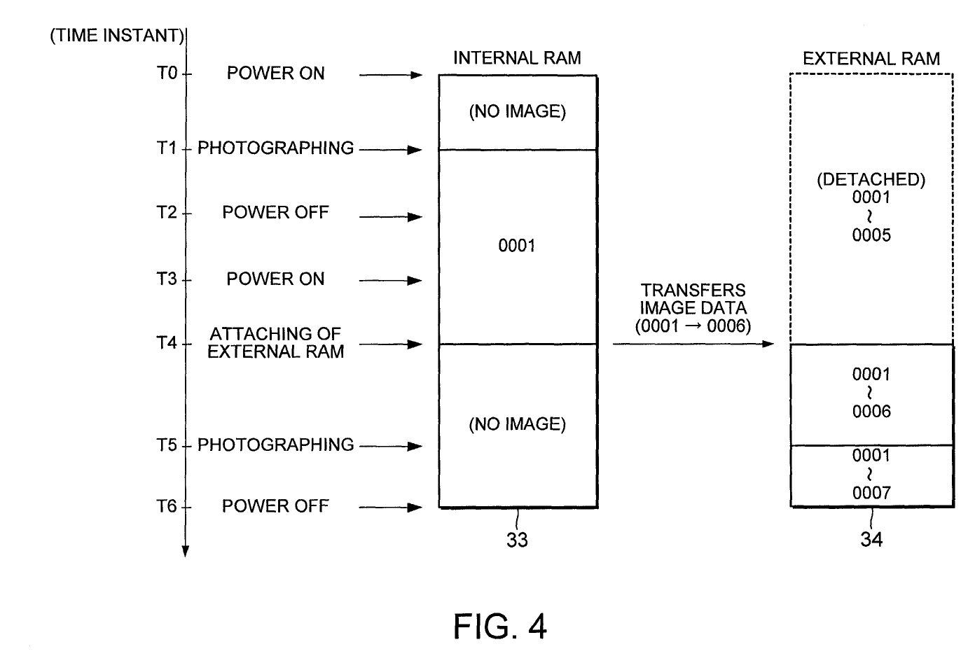

Referring now to FIG. 4, description will be made as regards operation of the digital still camera illustrated in FIG. 1.

At a time instant TO, the power supply of the digital still camera is turned on. In this event, it will be assumed that the external RAM 34 is detached from the digital still camera and the processed image data is not stored in the surplus area SA of the internal RAM 33. When the shutter bottom of the input unit 10 is pushed at a time instant T1, the photographing processing section 20 prepares the processed image data to delivers the processed image data to the image data storage device 30. The image data managing unit 31 confirms that the external RAM 34 is absent or is detached from the digital still camera and stores the processed image data having a file number of “0001” in the surplus area SA of the internal RAM 33. At a time instant T2, the power source switch of the digital still camera is turned off. Inasmuch as the processed image data is stored in the surplus area SA of the internal RAM 33, the power source control unit 50 continues to energize the internal RAM 33. The power source of the digital still camera is turned on again at a time instant T3. When the external RAM 34 storing the processed image data having file numbers of “0001” to “0005” is attached to the digital still camera at a time instant T4, the image data managing unit 31 transfers the processed image data having the file number of “0001” stored in the surplus area SA of the internal RAM 33 to the external RAM 34 with the file number of “0001” changed into a new file number of “0006.”

When the shutter bottom of the input unit 10 is pushed again at a time instant T5, the photographing processing section 20 prepares processed image data in the manner as a case of one piece and delivers the processed image data to the image data storage device 30. In this event, the image data managing unit 31 confirms that the external RAM 34 is attached to the digital still camera and stores the processed image data having a new file number of “0007” in the external RAM 34. When the power source switch of the digital still camera is turned off at a time instant T6, supply of the power source for all components of the digital still camera is stopped because the processed image data is already not stored in the surplus area SA of the internal RAM 33.

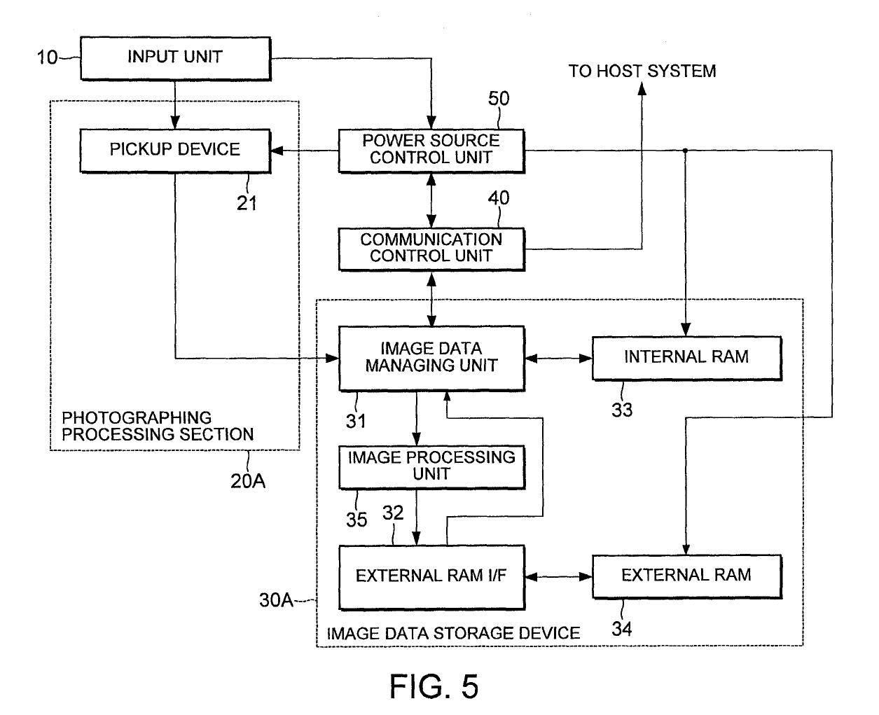

Referring to FIG. 5, the description will proceed to a digital still camera according to a second embodiment of this invention. The illustrated digital still camera is similar in structure and operation to the digital still camera illustrated in FIG. 1 except that the photographing processing section and the image data storage device are modified from those illustrated in FIG. 1 in the manner which will later become clear. The photographing processing section and the image data storage device are therefore depicted at 20A and 30A, respectively.

The photographing processing section 20A comprises only the pickup device 21. The image data storage device 30A comprises an image processing unit 35 as well as the image data managing unit 31, the external RAM interface 32, the internal RAM 33, and the external RAM 34. That is, the image processing unit 22 is omitted from the photographing processing section 20 (FIG. 1) and the image processing unit 35 is added to the image data storage device 30A.

The image processing unit 35 is connected to the image data managing unit 31 and the external RAM interface 32. In the manner which will become clear as the description proceeds, the image processing unit 35 is operable as only a case of storing a picked-up image in the external RAM 34 as processed image data. The image processing unit 35 processes picked-up data into the processed image data.

In addition, the internal RAM 33 stores the picked-up data or raw image data before image processing in lieu of the processed image data after image processing. More specifically, in the first embodiment, after the picked-up image is necessarily converted into the processed image data by the image processing unit 22, the processed image data is stored in either the internal RAM 33 or the external RAM 34. On the other hand, in the second embodiment, when the external RAM 34 is attached to the digital still camera, image processing is made as a time when data in the internal RAM 33 is transferred to the external RAM 34. That is, when photographing is carried out with the external RAM 34 detached, the picked-up image is stored in the internal RAM 33 as the picked-up data or the raw image data.

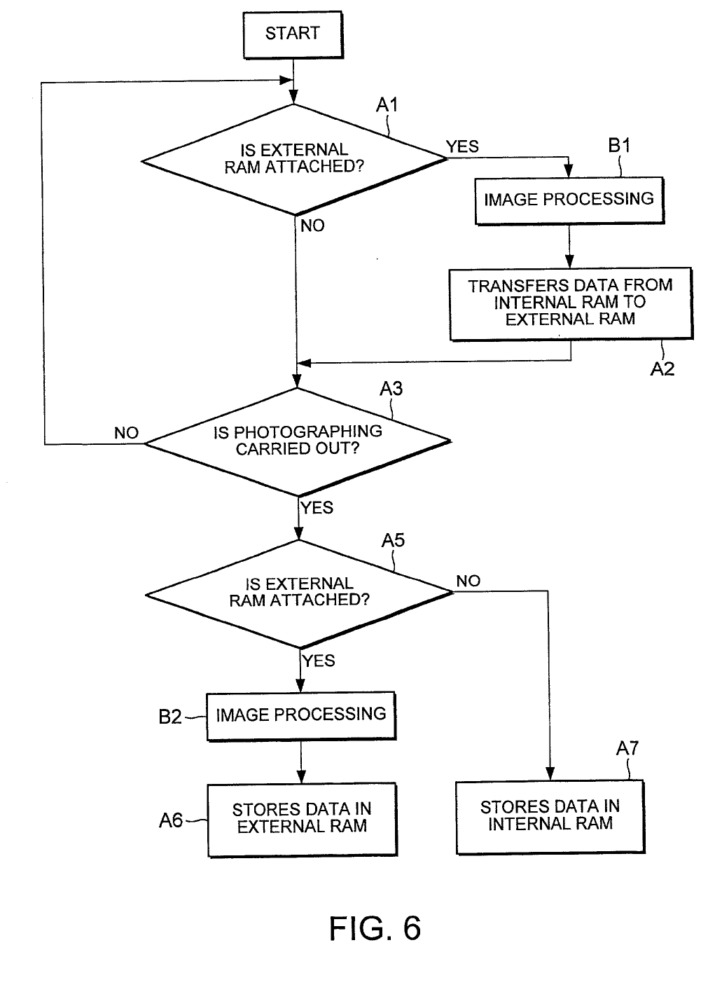

FIG. 6 is a flowchart for use in describing operation of the digital still camera illustrated in FIG. 5. The flowchart illustrated in FIG. 6 is similar in operation to the flowchart illustrated in FIG. 3 except that the step A4 is omitted from the flowchart illustrated in FIG. 3 and new steps B1 and B3 are added to the flowchart illustrated in FIG. 6 in the manner which will become clear as the description proceeds.

The external RAM interface 32 always monitors whether or not the external RAM 34 is attached to or detached from the digital still camera at the step A1. When the external RAM 34 is attached to the digital still camera, the image data managing unit 31 receives a notice from the external RAM interface 32. If the raw image data is stored in the surplus area SA of the internal RAM 33, the image data managing unit 31 makes the image processing unit 35 process the raw image data stored in the internal RAM 33 into the processed image data at the step B1. The step B1 is followed by the step A1 at which the image processing unit 35 transfers the processed image data to the external RAM 34 via the external RAM interface 32 as far as a capacity of the external RAM 34 permits at the step A2. Although a file name of the processed image data is ordinarily stored with the number in the order of photographing the digital still camera, in this case, the file number is rewritten, in accordance with an image number of the external RAM 34, from the following.

When photographing is carried out in the photographing processing section 20A to prepare the picked-up data, the image data managing unit 31 receives a notice from the photographing processing section 20A at the step A3. The image data managing unit 31 makes the external RAM interface 32 confirm the presence or absence of the external RAM 34 at the step A5. When the external RAM 34 is present or is attached to the digital still camera, the step A5 is followed by the step B2 at which the image data managing unit 31 makes the image processing unit 35 process the picked-up data into the processed image data. The step B2 proceeds to the step A6 at which the image processing unit 35 stores the processed image data in the external RAM 34 through the external RAM interface 32. When the external RAM 34 is absent or is detached from the digital still camera, the step A5 is succeeded by the step A7 at which the image data managing unit 31 stores the picked-up data in the surplus area SA of the internal RAM 33 as the raw image data.

The raw image data stored in the internal RAM 34 is transferred to the host system through the image data managing unit 31 and the communication control unit 40. The host system may comprise an image processing arrangement for processing the raw image data into the processed image data.

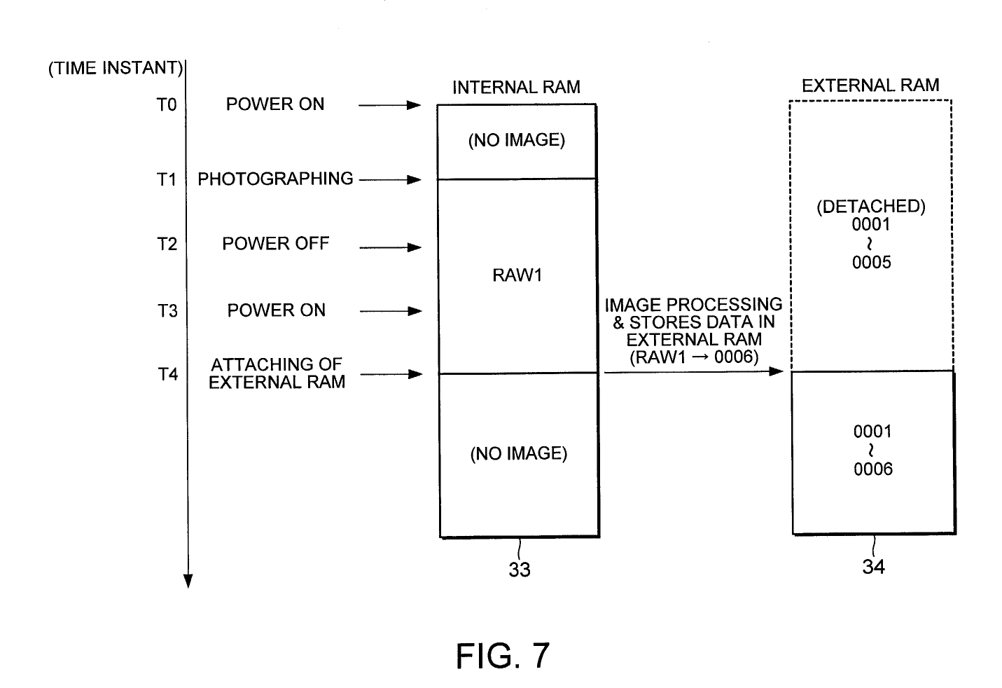

Referring now to FIG. 7, description will be made as regards operation of the digital still camera illustrated in FIG. 5.

At a time instant TO, the power source of the digital still camera is turned on. In this event, it will be assumed that the external RAM 34 is detached from the digital still camera and the raw image data is not stored in the surplus area SA of the internal RAM 33. When the shutter bottom of the input unit 10 is pushed at a time instant T1, the photographing processing section 20A prepares the picked-up data to delivers the picked-up data to the image data storage device 30A. The image data managing unit 31 confirms that the external RAM 34 is absent or is detached from the digital still camera and stores the picked-up data in the surplus area SA of the internal RAM 33 as raw image data RAW1 having a file number of one. At a time instant T2, the power source switch of the digital still camera is turned off. Inasmuch as the raw image data RAW1 is stored in the surplus area SA of the internal RAM 33, the power supply control unit 50 continues to energize the internal RAM 33. The power source of the digital still camera is turned on again at a time instant T3. When the external RAM 34 storing the processed image data having file numbers of “0001” to “0005” is attached to the digital still camera at a time instant T4, the image data managing unit 31 makes the image processing unit 35 process the raw image data into processed image data and the image processing unit 35 transfers the processed image data having a file number of “0006” to the external RAM 34.

In the above-mentioned second embodiment, the image processing is not carried out on actually carrying out photographing if the external RAM 34 is absent or is detached from the digital still camera. As a result, it is possible to shorten an interval of photographing. In addition, it is unnecessary to ensure a distinct area for image processing on the internal RAM 34. Accordingly, it is possible to assign a lot of areas to the internal RAM 34 by storing raw image data.

While this invention has thus far been described in conjunction with a preferred embodiment thereof, it will now be readily possible for those skilled in the art to put this invention into various other manners.

What is claimed is:

1. A digital still camera which contains a volatile internal memory device for use in an image processing process and to/from which a nonvolatile external memory device is attachable/detachable, said volatile internal memory device comprising a work area for said image processing process and a surplus area for storing image data photographed by said digital still camera.

2. A digital still camera as claimed in claim 1, wherein said digital still camera comprises storing means for temporarily storing said image data in said surplus area of said volatile internal memory device when said nonvolatile external memory device is detached from said digital still camera.

3. A digital still camera as claimed in claim 2, wherein said digital still camera further comprises transferring means for transferring said image data stored in said surplus area to said nonvolatile external memory device when said nonvolatile external memory is attached to said digital still camera.

4. A digital still camera as claimed in claim 2, wherein said digital still camera further comprises backup means for backing up said volatile internal memory device so that stored contents of the volatile internal memory device do not disappear although a power source switch of said digital still camera is put into an off state.

5. A digital still camera as claimed in claim 4, wherein said digital still camera further comprises transferring means for transferring said image data stored in said surplus area to said nonvolatile external memory device when said nonvolatile external memory is attached to said digital still camera.

6. A digital still camera as claimed in claim 2, wherein said digital still camera further comprises transferring means for transferring said image data stored in said surplus area to a host system.

7. A digital still camera as claimed in claim 4, wherein said digital still camera further comprises transferring means for transferring said image data stored in said surplus area to a host system.

8. A method of storing image data photographed by a digital still camera which contains a volatile internal memory device for use in an image processing process and to/from which a nonvolatile external memory device is attachable/detachable, said method comprising the step of using a surplus area for storing said image data except for a work area for said image processing process.

9. A method as claimed in claim 8, wherein processed image data after image processing is stored in said surplus area.

10. A method as claimed in claim 8, wherein said method further comprises the steps of:
determining whether said nonvolatile external memory device is attached to or detached from said digital still camera; and
when said nonvolatile external memory device is attached to said digital still camera, transferring stored contents of said surplus area to said nonvolatile external memory device.

11. A method as claimed in claim lo, wherein said method further comprises the steps of:
carrying out image processing on raw image data to produce said processed image data when said nonvolatile external memory device is detached from said digital still camera; and
temporarily storing said processed image data in said surplus area.

12. A method as claimed in claim 8, wherein raw image data before image processing is stored in said surplus area.

13. A method as claimed in claim 12, wherein said method further comprises the steps of:
determining whether said nonvolatile external memory device is attached to or detached from said digital still camera;
when said nonvolatile external memory device is attached to said digital still camera, carrying out image processing on said raw image data of said surplus area to produce processed image data; and
transferring said processed image data to said nonvolatile external memory device.

14. A method as claimed in claim 13, wherein said method further comprises the step of temporarily storing, as said raw image data, picked-up data photographed by said digital still camera in said surplus area when said nonvolatile external memory device is detached from said digital still camera.
